(19) United States
(12) Patent Application Publication
(10) Pub. No.: US 2005/0278619 A1
(43) Pub. Date: Dec. 15, 2005

(54) Apparatus and method of transmitting/storing print or display control information, and recording medium having embodies thereon computer program for executing the method

(75) Inventors: Du-il Kim, Suwon-si (KR); Kwang-chul Lee, Suwon-si (KR); Eun-hee Rhim, Suwon-si (KR); Seok Ryu, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/135,270

(22) Filed: May 24, 2005

(30) Foreign Application Priority Data
Jun. 14, 2004 (KR) 10-2004-0043455
Sep. 21, 2004 (KR) 10-2004-0075471

(51) Int. Cl. G06F 17/00

(52) U.S. Cl. 715/513; 358/1.15; 715/526; 715/500.1

(57) ABSTRACT

An apparatus and method of transmitting and storing print or display control information for printing or displaying an asset in various formats, and a recording medium having embodied thereon a computer program for executing the method. The print or display control information transmission and storage method includes: generating a first file including metadata and a print or display order for controlling printing or displaying of the asset; generating a second file on the basis of the metadata and the print or display order included in the first file and print or display form information for the asset; and selecting and transmitting one of the first file and the second file according to operation conditions of a device for printing or displaying the asset.

### BACKGROUND OF THE INVENTION

This application claims the priorities of Korean Patent Application No. 10-2004-0043455, filed on Jun. 14, 2004, and No. 10-2004-0075471, filed on Sep. 21, 2004, in the Korean Intellectual Property Office, the disclosures of which are incorporated herein by reference in their entirety.

1. Field of the Invention

The present invention relates to an apparatus and method of transmitting/storing print or display control information, and more particularly, to an apparatus and method of transmitting/storing ML (Markup Language)-based print or display control information in capture devices or IT (Information Technology) devices, and a recording medium having embodied thereon a computer program for executing the method.

2. Description of the Related Art

Capture devices include CE (Consumer Electronics) devices such as a digital camera, a digital camcorder, and a mobile terminal with a digital camera function. Such capture devices can capture various media such as still images, general images, and texts. IT devices, such as PCs (Personal Computers), can store various media that can be classified as items or assets.

The assets are classified into simple media assets and composite media assets. The simple media assets may be digital photos, videos, digital audios, texts, etc. The composite media assets may be “digital photos+digital audios”, multi-shot sequenced photos, panorama-shot sequenced photos, etc.

However, when a capture device or an IT device is connected to a CE device such as a printer or television and assets are output, only raw data corresponding to each asset without any print or display control information will be transmitted from the capture device or IT device to the CE device.

Accordingly, the printer or television cannot print or display the assets in a batch print format or in a specific format. The batch print is a function for marking a desired asset of a plurality of assets and printing the marked asset using a batch job. The specific format may be a format for composing composite medias, a format capable of providing effects such as cropping or rotation, or a format capable of providing specific contents group types such as multi-shot and panorama-shot.

### SUMMARY OF THE INVENTION

Exemplary embodiments of the invention address the problems of the conventional art. In particular, the present invention provides an apparatus and method of transmitting print or display control information to print or display assets in various formats, and a recording medium having embodied thereon a computer program for executing the method.

The present invention also provides an apparatus and method of transmitting ML (Markup-Language)-based print or display control information in a capture device or an IT device, and a recording medium having embodied thereon a computer program for executing the method.

The present invention also provides an apparatus and method of transmitting print or display control information on the basis of XML (eXtension Markup Language)-based print or display order information and XHTML (extension HyperText Markup Language)-based print or display form information, and a recording medium having embodied thereon a computer program for executing the method.

The present invention also provides an apparatus and method of storing print or display control information to print or display assets in various formats, and a storage medium for storing a computer program for executing the method.

The present invention also provides an apparatus and method of storing ML-based print or display control information, and a storage medium storing a computer program for executing the method.

The present invention also provides a print or display control information storage apparatus and method of independently storing XML-based print or display order information and XHTML-based print or display form information, and a storage medium storing a computer program for executing the method.

Consistent with an aspect of the present invention, there is provided a method of transmitting print or display control information for an asset, comprising: generating a first file including metadata and a print or display order for controlling printing or displaying of the asset; generating a second file on the basis of the metadata and the print or display order included in the first file and print or display form information for the asset; and selecting and transmitting one of the first file and the second file according to operation conditions of a device for printing or displaying the asset.

The first file is an XML-based MPV file and the second file is an XHTML file.

The generating of the first file comprises: generating, as the first file, a print or display control MPV file for controlling printing or displaying of the asset, obtained on the basis of user input information for controlling printing or displaying of the asset and an MPV file managing information capable of reading and reproducing the asset.

The first file manages information for controlling printing or displaying of the asset, including at least one of a print or display order, an asset property, an asset reference, metadata to be output with the asset, and marking information for an image to be printed or displayed.

The second file selects and defines one print or display form among a plurality of print or display forms.

Consistent with another aspect of the present invention, there is provided a method of storing print or display control information for an asset, comprising: generating a first file for managing metadata and a print or display order for controlling printing or displaying of the asset; generating a second file defining a print or display form of the asset with reference to the metadata and the print or display order managed by the first file; generating synchronization data for synchronizing the first file and the second file; and individually storing the first file and the second file, wherein the stored first file and second file include the generated synchronization data.

In an exemplary embodiment, the synchronization data includes an asset reference of the asset.

Consistent with another aspect of the present invention, there is provided a method of transmitting and storing print or display control information for an asset, comprising: generating a first file managing metadata and a print or display order for controlling printing or displaying of the asset; generating a second file defining a print or display form of the asset with reference to the metadata and the print or display order managed by the first file; generating synchronization data for synchronizing the first file and the second file; inserting the generated synchronization data in the first file and the second file and individually storing the first file and the second file; and selecting and transmitting one of the first file and the second file according to operation conditions of a device for printing or displaying the asset.

Consistent with another aspect of the present invention, there is provided an apparatus for transmitting print or display control information for an asset, comprising: a first file generator generating a first file including metadata and a print or display order for controlling printing or displaying of the asset; a second file generator generating a second file on the basis of the metadata and the print or display order included in the first file and print or display form information for the asset; and a transmitter selecting and transmitting one of the first file and the second file according to operation conditions of a device for printing or displaying the asset. Further, in an exemplary embodiment, the transmitter is a multiplex engine.

The apparatus further comprises: a user interface transmitting information input by a user to the first file generator, to the second file generator, and to the transmitter, and providing an environment through which the user inputs the information.

Consistent with another aspect of the present invention, there is provided an apparatus for storing print or display control information for an asset, comprising: a first file generator generating a first file managing metadata and a print or display order for controlling printing or displaying of the asset; a second file generator generating a second file defining a print or display form of the asset with reference to the metadata and the print or display command managed by the first file; a memory individually storing the first file and the second file; and a memory controller generating synchronization data for synchronizing the first file and the second file and controlling the memory so that the generated synchronization data is included in both the first file and the second file.

Consistent with another aspect of the present invention, there is provided a computer-readable recording medium having embodied thereon a computer program enabling a computer to execute an asset print or display control information transmission method comprising: generating a first file including metadata and a print or display order for controlling printing or displaying of an asset; generating a second file on the basis of the metadata and the print or display order included in the first file and print or display format information of the asset; and selecting and transmitting one of the first file and the second file according to operation conditions of a device for printing or displaying the asset.

Consistent with another aspect of the present invention, there is provided a computer-readable medium having embodied thereon a computer program enabling a computer to execute an asset print or display control information transmission method, comprising: generating a first file managing metadata and a print or display order for controlling printing or displaying of the asset; generating a second file defining a print or display form of the asset with reference to the metadata and the print or display order managed by the first file; generating synchronization data for synchronizing the first file and the second file; and individually storing the first file and the second file, wherein the stored first file and second file include the generated synchronization data.

### BRIEF DESCRIPTION OF THE DRAWINGS

The above and other features and advantages of the present invention will become more apparent by describing in detail exemplary embodiments thereof with reference to the attached drawings in which:

FIG. 1 is a functional block diagram of a print or display control information transmission apparatus consistent with an exemplary embodiment of the present invention;

FIG. 2 is a view for explaining the operations of an MPV file generator and an XHTML file generator shown in FIG. 1;

FIGS. 3A through 3E show an exemplary source code of an XML-based MPV file generated by the MPV file generator shown in FIG. 1;

FIG. 4 is another view for explaining the operations of the MPV file generator and the XHTML file generator shown in FIG. 1;

FIG. 5 is a functional block diagram of a print or display control information transmission and storage apparatus consistent with another exemplary embodiment of the present invention;

FIG. 6 is a flowchart illustrating a print or display control information transmission method consistent with an exemplary embodiment of the present invention; and

FIG. 7 is a flowchart illustrating a print or display control information storage method consistent with another exemplary embodiment of the present invention.

### DETAILED DESCRIPTION OF THE INVENTION

Hereinafter, exemplary embodiments of the present invention will be described in detail with reference to the appended drawings. Like reference numbers refer to like components throughout the drawings.

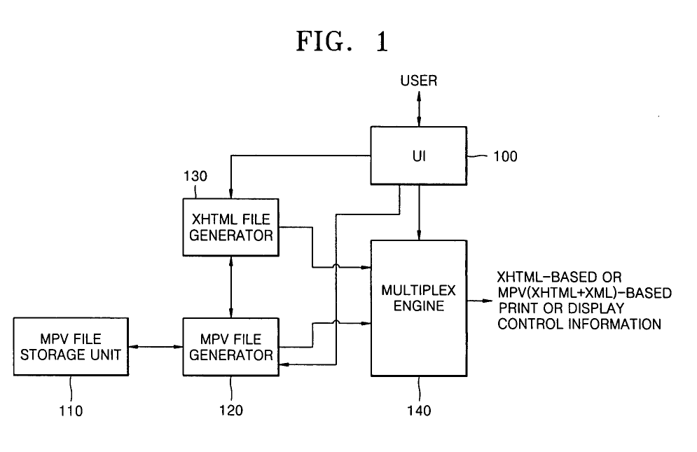

FIG. 1 is a functional block diagram of a print or display control information transmission apparatus consistent with an exemplary embodiment of the present invention. The print or display control information transmission apparatus can be included in a CE device or IT device. Referring to FIG. 1, the print or display control information transmission apparatus includes a User Interface (UI) 100, an MPV (MultiPhotoVideo or MusicPhotoVideo) file storage unit 110, an MPV file generator 120, an XHTML (eXtension HyperText Markup Language) file generator 130, and a multiplex engine 140.

The UI 100 provides user input information for controlling printing or displaying of each asset or item, to the MPV file generator 120, to the XHTML file generator 130, and to the multiplex engine 140, while providing an environment in which a user can input information.

The assets may be simple media assets such as still images, general images, and texts, or may be composite media assets such as multi-shot sequenced photos and panorama-shot sequenced photos.

The environment, for example, is an environment in which the user can input an asset type, metadata of an asset to be printed, the number of prints, an effect required for each asset, an asset property such as a print format or a display format, a print job schedule, location information (asset reference) of an asset to be printed or displayed, etc.

Generally, a user cannot input various information to conventional information input apparatuses used in CE devices. Therefore, the UI 100 is constructed to provide an environment allowing a user to input print or display control information through a simple information input apparatus. For example, the UI 100 can provide an environment allowing a user to input print or display control information through a menu screen. In this case, information displayed on the menu screen can be provided from the MPV file generator 120 and the XHTML file generator 130.

The MPV file storage unit 110 stores MPV files capable of managing metadata of all assets included in a corresponding CE device or IT device and location information (asset references) of the assets. The assets managed by the MPV files may include assets (for example, digital audio assets) that cannot be printed or displayed. Accordingly, the MPV files stored in the MPV file storage unit 110 are XML-based files as raw files including information for the attributes and locations of captured medias. Therefore, the MPV files can be used to read and reproduce the captured medias.

The MPV file generator 120 generates order information for printing or displaying the assets and the MPV files managing the metadata. The MPV file generator 120 converts MPV files stored in the MPV file storage unit 110 to XML-based files for controlling printing or displaying of assets, according to the information received from the UI 100. The XML-based files are the MPV files generated by the MPV file generator 120. Hereinafter, the MPV file generated by the MPV file generator 120 is referred to as a newly defined MPV file.

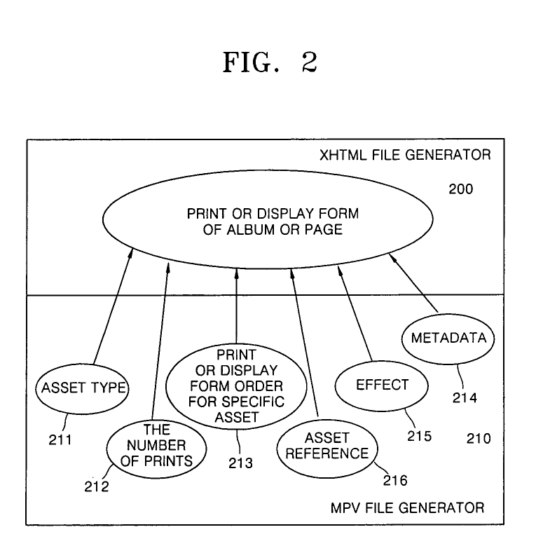

The newly defined MPV file manages factors required for printing or displaying assets. For example, the factors can include an asset type 211, the number of prints 212, a print or display form order for a specific asset 213, metadata 214, an effect 215, an asset reference 216, etc., as shown in FIG. 2.

The asset type 211 is information indicating the type of an asset to be printed or displayed. For example, the asset type 211 is information indicating whether an asset to be printed is a still image, a multi-shot sequenced photo, or a panorama-shot sequenced photo. The asset type 211 can be decided with reference to asset type information managed by an MPV file stored in the MPV file storage unit 110.

The number of prints 212 is information representing the number of assets to be printed or the number of albums including a plurality of assets, and can be decided according to the user input information.

The print or display form order for the specific asset 213 is information indicating whether or not a selected asset is used for a cover. If a selected asset is used for a cover, the print or display form order for the specific asset 213 can define information for including a different image or specific metadata such as an album title. The information can be defined according to the user input information.

The metadata 214 is information representing specific metadata to be printed or displayed together with each asset to be printed or displayed. The metadata 214 can be defined according to the user input information or can be decided with reference to associated metadata managed by an MPV file stored in the MPV file storage unit 110. The user can input metadata in which an image to be printed or displayed with the metadata is marked.

Also, the user can input metadata in which a plurality of desired assets to be printed or displayed among assets capable of being printed or displayed, are marked. In a device which prints or displays assets using the metadata, a batch print for grossly printing or displaying a plurality of assets can be used. Also, the user can input metadata in which assets are marked to be printed or displayed in a multi-shot format or in a panorama-shot format.

The effect 215 is information defining an effect such as cropping or rotation to be reflected for each asset to be printed or displayed.

The asset reference 216 is information defining an actual location of an asset to be printed or displayed, and can be defined as a LastURL that is managed by an MPV file stored in the MPV file storage unit 110 on the basis of the user input information.

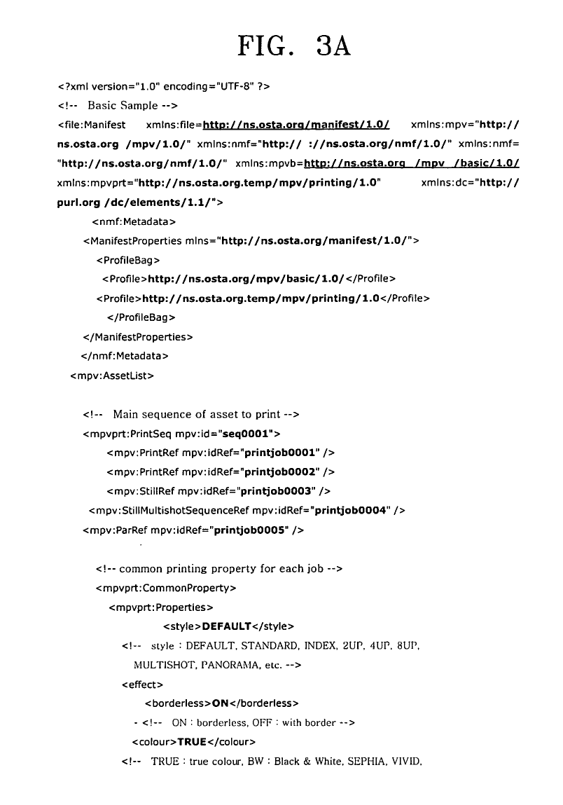

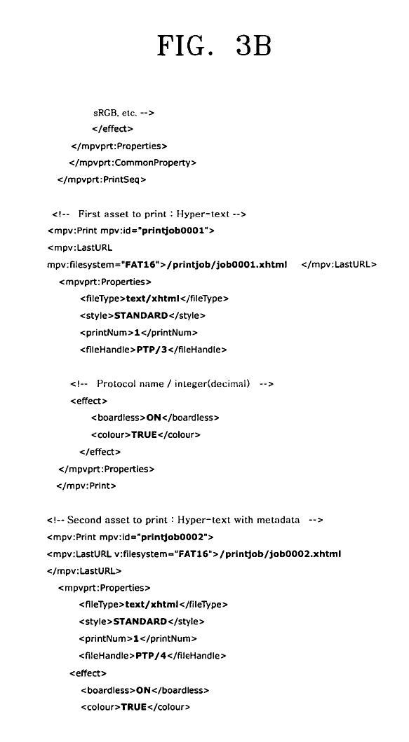

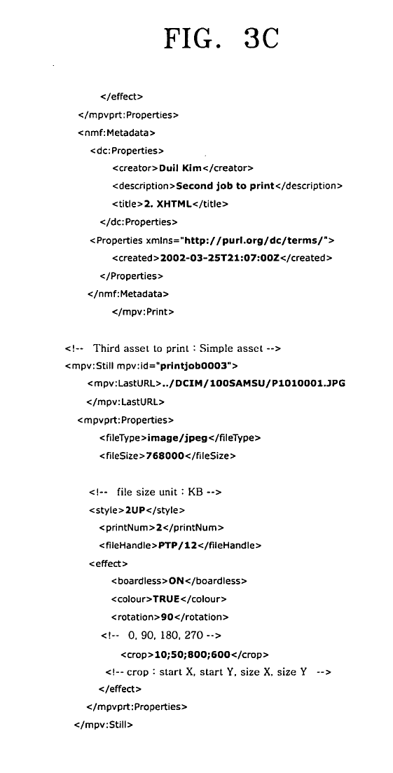

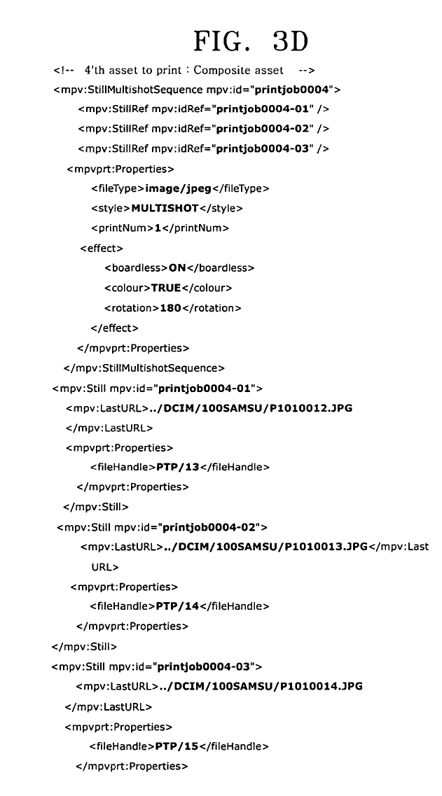

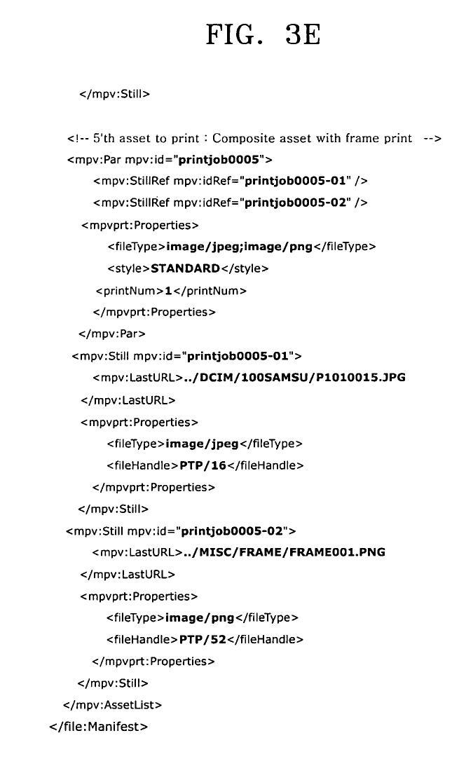

An example of the newly defined MPV file generated by the MPV file generator 120 is shown as a source code in FIGS. 3A through 3E. Referring to FIGS. 3A through 3E, information including asset properties such as a print job schedule of assets to be printed or displayed, styles, file types, the number of prints, fileHandle, and titles, and asset effects such as borderless, color, rotation, and cropping, etc., is defined in the MPV file. Also, the newly defined MPV file can be defined as information to be processed in an HTML format. That is, referring to FIG. 3B, <mpv:Print mpv:id=“printjob0001”> is processed in the HTML format by “<!--first asset to print:Hyper-text →”. The newly defined MPV file generated by the MPV file generator 120 can be transmitted to the multiplex engine 140.

Also, the factors managed by the MPV file generator 210 of FIG. 2 can be used as input factors when a print or display control XHTML file is generated. That is, the XHTML file generator 200 of FIG. 2 generates an XHTML file in which a print or display format of an album or page is defined, with reference to a print or display order and metadata of each asset managed by the MPV file generator 210. That is, the MPV file generator 120 may be defined as a manager for managing input factors of a print or display control XHTML file.

The XHTML file generator 130 generates the print or display control XHTML file, on the basis of print or display order information included in a newly defined MPV file generated by the MPV file generator 120 and a print or display form selected by the user through the UI 100. To allow the user to select the print or display form, the XHTML file generator 130 provides pre-stored various templates to the user through the UI 100. The various templates can include a layout for a special page, a layout for one page, a layout for a composite asset, etc.

In other words, the XHTML file generator 130 can generate the print or display control XHTML file, using print or display form information selected by the user and a print or display order and metadata managed by the newly defined MPV file generated by the MPV file generator 120. The generated XHTML file can be transmitted to the multiplex engine 140.

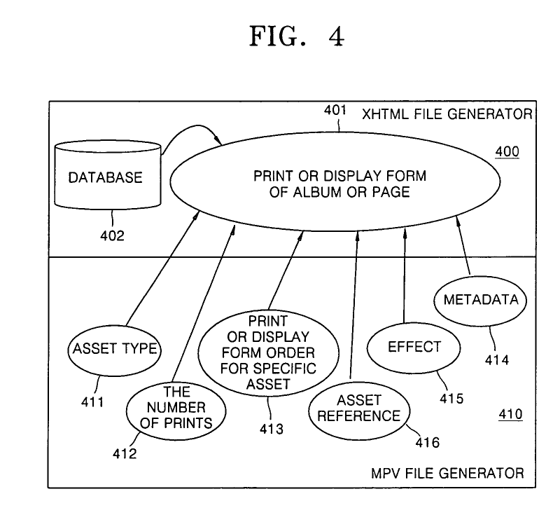

FIG. 4 is another view for explaining the operations of the MPV file generator 120 and the XHTML file generator 130 shown in FIG. 1. Unlike FIG. 2, an XHTML file generator 400 of FIG. 4 includes a database 402. Like the above descriptions for the XHTML file generator 130 of FIG. 1, templates including various print or display formats are stored in the database 402, to allow a user to select one among the stored templates. Here, the XHTML file generator 400 refers input factors for controlling printing or displaying of each asset, which are managed by the MPV file generator 410.

The multiplex engine 140 mine-multiplexes an MPV file generated by the MPV file generator 120 and an HTML file generated by the XHTML file generator 130. The mine-multiplexing is performed in response to a control signal received through the UI 100. That is, if an XHTML file is required by a control signal received through the UI 100, the multiplex engine 140 selects the XHTML file and outputs it in response to the control signal. If an MPV file is required by a control signal received through the UI 100, the multiplex engine 140 selects the MPV file and outputs it in response to the control signal. The MPV file may be an (XHTML+XML)-based file, as shown in FIGS. 3A through 3E. The (XHTML+XML)-based file is an XML-based file capable of printing or displaying assets in an XHTML format according to contents.

A control signal input to the multiplex engine 140 through the UI 100 performs different operations according to a processing capability of a CE device or IT device for printing or displaying assets. If a corresponding CE device or IT device can receive XHTML-based print or display control information, the control signal allows the multiplex engine 140 to select an XHTML file and transmit it. If a corresponding CE device or IT device can receive XML-based print or display control information, the control signal allows the multiplex engine 140 to select an MPV file and transmit it. Accordingly, the multiplex engine 120 may be defined as a transmitter which transmits an XHTML file output from the XHTML file generator 130 and an MPV file output from the MPV file generator 120, as output information.

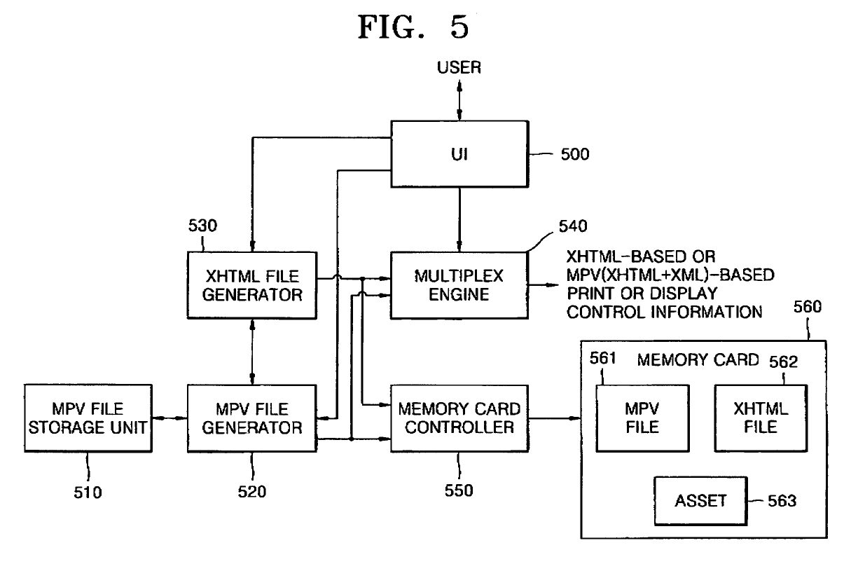

FIG. 5 is a functional block diagram of a print or display control information transmission and storage apparatus consistent with another embodiment of the present invention, wherein the print or display control information transmission and storage apparatus stores created print or display information and simultaneously transmits it to a CE device or IT device.

Referring to FIG. 5, the print or display control information transmission and storage apparatus includes an UI 500, an MPV file storage unit 510, an MPV file generator 520, an XHTML file generator 530, an multiplex engine 540, a memory card controller 550, and a memory card 560.

The UI 500, the MPV file storage unit 510, the MPV file generator 520, the XHTML file generator 530, and the multiplex engine 540 shown in FIG. 5 operate in the same manner as the UI 100, the MPV file storage unit 110, the MPV file generator 120, the XHTML file generator 130, and the multiplex engine 140 shown in FIG. 1, and therefore detailed descriptions thereof are omitted.

However, the MPV file generator 520 and the XHTML file generator 530 transmit a created MPV file and a created XHTML file to the memory card controller 550 as well as to the multiplex engine 540.

The memory card controller 550 individually stores an XHTML file 562 created by the XHTML file generator 530 and an MPV file 561 created by the MPV file generator 520 in the memory card 560. At this time, the memory card controller 550 generates synchronization data and stores it with the MPV file 561 and XHTML file 562 such that the respective MPV file 561 and XHTML file 562 stored in the memory card 560 include predetermined synchronization data.

If location information (asset reference) of an asset to be printed or displayed indicates synchronization data for synchronization of the MPV file 561 and the XHTML file 562, the memory card controller 550 creates synchronization data with reference to the location information of a corresponding asset 563 stored in the memory card 560 and the location information of a corresponding asset defined in a newly defined MPV file, and individually stores MPV and XHTML files each including the created synchronization data in the memory card 560. Accordingly, the MPV file 561 is an MPV file including the synchronization data created by the memory card controller 550 and the XHTML file 562 is an XHTML file including the synchronization data created by the memory card controller 550.

The print or display control information transmission apparatus of FIG. 1 and the print or display control information transmission and storage apparatus of FIG. 5 can be included in a capture device or IT device. The memory card controller 550 and the memory card 560 can be external devices connected to the capture device or IT device.

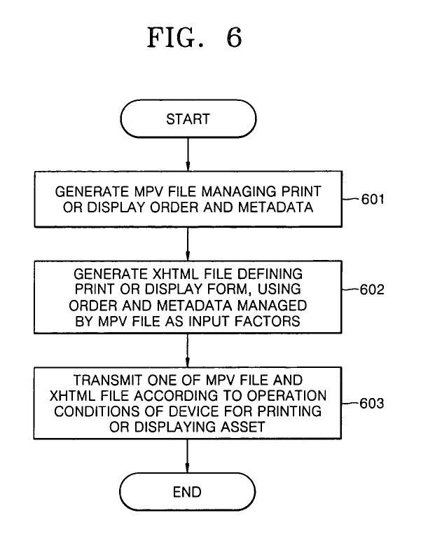

FIG. 6 is a flowchart illustrating a print or display control information transmission method consistent with an exemplary embodiment of the present invention.

First, an MPV file for managing metadata and print or display control commands of assets for printing or displaying the assets are created (operation 601). Here, the created MPV file is the newly defined MPV file mentioned above with reference to FIG. 1. The MPV file is created using user input information received through the UI 100 and a raw MPV file stored in the MPV file storage unit 110. The user input information is information for controlling printing or displaying of the assets. The raw MPV file includes location information (or asset references) and metadata of the assets. Accordingly, the MPV file created in operation 601 manages asset-associated information including print or display orders, asset properties, asset references, etc.

Then, an XHTML file, which defines a print or display form selected by a user among a plurality of pre-defined print or display forms, is created, using the print or display orders and metadata managed by the MPV file created in operation 601, as input factors (operation 602).

Considering the operation conditions of a corresponding device (not shown) for printing or displaying the assets, one of the MPV file created in operation 601 and the XHTML file created in operation 602 is selected according to the information input by a user and the selected file is transmitted to the device (operation 603). Here, a method of selecting one of the MPV file and the XHTML file is described with reference to the multiplex engine 140 of FIG. 1. The device may be a CE device such as a printer or television.

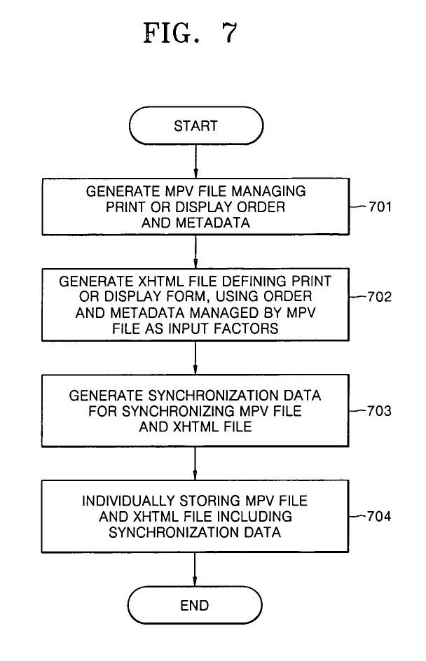

FIG. 7 is a flowchart illustrating a print or display control information storage method consistent with another exemplary embodiment of the present invention.

First, an MPV file for managing metadata of assets and print or display orders for printing or displaying the assets is created (operation 701). Here, the created MPV file is the newly defined MPV file shown in FIG. 1. The MPV file is created using user input information received through the UI 100 and a raw MPV file stored in the MPV file storage unit 110. The user input information is information for controlling printing or displaying of assets. The raw MPV file includes asset references and metadata of assets. Accordingly, the MPV file created in operation 701 manages asset-associated information including print or display orders, asset properties, asset references, etc.

Then, an XHTML file, which defines a print or display form selected by a user among a plurality of pre-defined print or display forms, is created, using the print or display orders and metadata managed by the MPV file created in operation 701, as input factors (operation 702).

Then, synchronization data for synchronizing the MPV file created in operation 701 and the XHTML file created in operation 702 is created (operation 703). The synchronization data can be created using the asset references stored in the memory card 560 and the asset references defined in the MPV file created in operation 701, as described above with reference to FIG. 5. For example, if an asset reference stored in the memory card 560 is different from a corresponding asset reference defined in the MPV file, the asset reference stored in the memory card 560 is created as the synchronization data. The synchronization data is data which the MPV file and XHTML file commonly include for the same asset.

The created synchronization data is included in the MPV file created in operation 701 and the XHTML file created in operation 702. Here, the synchronization data can be inserted into both the MPV file and the XHTML file by updating LastURL of an asset managed by the MPV file created in operation 701 to the location of a corresponding asset presently stored in the memory card 560. Then, the MPV file and XHTML file including the synchronization data are individually stored in the memory card (operation 704).

FIG. 6 is a view for explaining the print or display control information transmission method and FIG. 7 is a view for explaining the print or display control information storage method. On the basis of the print or display control information transmission method of FIG. 6 and the print or display control information storage method of FIG. 7, it is possible to implement a method of transmitting the print or display control information and simultaneously storing it, using the print or display information transmission and storage apparatus shown in FIG. 5.

The print or display control information transmission and storage method consistent with the present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed over network coupled computer systems so that the computer readable code is stored and executed in a distributed fashion.

As described above, consistent with the present invention, by storing print or display control information defining a print or display form with reference to print or display orders and metadata, and simultaneously transmitting the print or display control information to a device for printing or displaying assets, it is possible to quickly print or display the assets in various forms.

For example, it is possible to store and transmit marking information capable of batch-printing a plurality of assets, information for the number of prints, print or display control information in which effect information such as cropping or rotation is marked for each asset, etc., using an XML-based MPV file consistent with the present invention.

Also, when an image asset is printed or displayed, it is possible to define an XML-based MPV file so that metadata with specific content is printed or displayed with the image asset. The XML-based MPV file can include information designating metadata to be output with a photo. Also, it is possible to create an MPV file so that images with a specific format such as a multi-shot format or a panorama-shot format can be printed or displayed. Further, a device for printing or displaying assets can reduce a time required for searching for assets to be printed or displayed, using information included in an MPV file.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of transmitting print or display control information for an asset, comprising:
generating a first file comprising metadata and a print or display order for controlling printing or displaying of the asset;
generating a second file on the basis of the metadata and the print or display order included in the first file and print or display form information for the asset; and
selecting and transmitting one of the first file and the second file according to operation conditions of a device for printing or displaying the asset.

2. The method of claim 1, wherein the first file is an XML-based MPV file and the second file is an XHTML file.

3. The method of claim 1, wherein the generating of the first file comprises:
generating, as the first file, a print or display control MPV file for controlling printing or displaying of the asset, obtained on the basis of user input information for controlling printing or displaying of the asset and an MPV file managing information capable of reading and reproducing the asset.

4. The method of claim 3, wherein the first file manages information for controlling printing or displaying of the asset, including at least one of a print or display order, an asset property, an asset reference, metadata to be output with the asset, and marking information for an image to be printed or displayed.

5. The method of claim 1, wherein the second file selects and defines one print or display form among a plurality of print or display forms.

6. A method of storing print or display control information for an asset, comprising:
generating a first file for managing metadata and a print or display order for controlling printing or displaying of the asset;
generating a second file defining a print or display form of the asset with reference to the metadata and the print or display order managed by the first file;
generating synchronization data for synchronizing the first file and the second file; and
individually storing the first file and the second file, wherein the stored first file and second file comprise the generated synchronization data.

7. The method of claim 6, wherein the first file is an XML-based MPV file and the second file is an XHTML file.

8. The method of claim 6, wherein the second file selects and defines one print or display form of a plurality of print or display forms.

9. The method of claim 6, wherein the synchronization data comprises an asset reference of the asset.

10. A method of transmitting and storing print or display control information for an asset, comprising:
generating a first file managing metadata and a print or display order for controlling printing or displaying of the asset;
generating a second file defining a print or display form of the asset with reference to the metadata and the print or display order managed by the first file;
generating synchronization data for synchronizing the first file and the second file;
inserting the generated synchronization data in the first file and the second file and individually storing the first file and the second file; and
selecting and transmitting one of the first file and the second file according to operation conditions of a device for printing or displaying the asset.

11. An apparatus for transmitting print or display control information for an asset, comprising:
a first file generator generating a first file comprising metadata and a print or display order for controlling printing or displaying of the asset;
a second file generator generating a second file on the basis of the metadata and the print or display order included in the first file and print or display form information for the asset; and
a transmitter selecting and transmitting one of the first file and the second file according to operation conditions of a device for printing or displaying the asset.

12. The apparatus of claim 11, wherein the first file is an XML-based MPV file and the second file is an XHTML file.

13. The apparatus of claim 11, wherein the first file manages information for controlling printing or displaying of an asset, comprising at least one of a print and display order, an asset property, an asset reference, metadata to be output with the asset, and marking information for an image to be printed or displayed.

14. The apparatus of claim 11, wherein the first file is a defined MPV file for controlling printing or displaying of the asset, obtained using an MPV file managing user input information for controlling printing or displaying of the asset and information capable of reading and reproducing the asset.

15. The apparatus of claim 11, wherein the transmitter is a multiplex engine.

16. The apparatus of claim 11, further comprising:
a user interface transmitting information input by a user to the first file generator, to the second file generator, and to the transmitter, and providing an environment through which the user inputs the information.

17. An apparatus for storing print or display control information for an asset, comprising:
a first file generator generating a first file managing metadata and a print or display order for controlling printing or displaying of the asset;
a second file generator generating a second file defining a print or display form of the asset with reference to the metadata and the print or display command managed by the first file;
a memory individually storing the first file and the second file; and
a memory controller generating synchronization data for synchronizing the first file and the second file and controlling the memory so that the generated synchronization data is included in both the first file and the second file.

18. The apparatus of claim 17, wherein the synchronization data comprises an asset reference of the asset.

19. A computer-readable recording medium having embodied thereon a computer program enabling a computer to execute an asset print or display control information transmission method comprising:
generating a first file including metadata and a print or display order for controlling printing or displaying of an asset;
generating a second file on the basis of the metadata and the print or display order included in the first file and print or display format information of the asset; and
selecting and transmitting one of the first file and the second file according to operation conditions of a device for printing or displaying the asset.

20. A computer-readable medium having embodied thereon a computer program enabling a computer to execute an asset print or display control information transmission method, comprising:
generating a first file managing metadata and a print or display order for controlling printing or displaying of the asset;
generating a second file defining a print or display form of the asset with reference to the metadata and the print or display order managed by the first file;
generating synchronization data for synchronizing the first file and the second file; and
individually storing the first file and the second file, wherein the stored first file and second file include the generated synchronization data.
